(19) United States
(12) Patent Application Publication
(10) Pub. No.: US 2004/0226888 A1
(43) Pub. Date: Nov. 18, 2004

(54) Two stage sterilization of fluids that naturally support microbiological growth

(76) Inventors: Dilip I. Chandarana, Stockton, CA (US); Tim J. Birmingham, Clements, CA (US)

Correspondence Address: The Halvorson Law Firm, Ste. 1, 405 W. Southern Ave., Tempe, AZ, 85282, US

(21) Appl. No.: 10/438,222

(22) Filed: May 14, 2003

(51) Int. Cl. B01D 61/00

(52) U.S. Cl. 210/650; 210/748; 210/764; 210/749; 210/774

(57) ABSTRACT

Disclosed is a method and apparatus that can extend the normal storage period of fluids that naturally support microbiological growth. The method and device uses a two-stage method whereby certain microorganisms of a predetermined size (0.45 microns) are initially filtered out whereas other, smaller, microorganisms pass through the selected filter and are inactivated using other methods such as mild heat, electromagnetic (non-ionizing) waves, or chemical methods. This method improves will allow more practical commercial production runtimes without any negative impact on the sterility of the fluid in question.

### FIELD OF INVENTION

The present invention relates to the field of sterilization of fluids that naturally support microbial growth and are stored for extended periods of time before they are consumed orally, fed via a tube, fed intravenously, or injected. More particularly, the present invention relates to the field of two step sterilization of fluids where the first step is filtration followed by non-filtration sterilization.

### BACKGROUND OF INVENTION

Currently, there are a number of foods, drugs, flavors, extracts, nutraceuticals, functional ingredients, and essences in the market that are stored without refrigeration. The microbiological stability of these materials is assured by either heat or chemical treatment. Chemical treatment is not always desirable. In addition, there are a number of products that have added flavors, extracts, nutraceuticals, functional ingredients, and essences, that are commercially processed by heat sterilization and packaged aseptically to the point where they can be stored without refrigeration. However, the flavors, extracts, and essences that are added to products are very expensive and very heat labile and have to be added in “excess” in order to meet product quality requirements. In addition, there are certain nutraceuticals and functional ingredients that simply cannot be used as they are very heat labile and will not survive a commercial heat sterilization process. Thus, it is very desirable to find a method to sterilize materials such as these without excessive heat.

Filter sterilization, a method commonly used, is one way to non-thermally sterilize solutions. However, the filters that are required by the Food and Drug Administration (FDA) have a porosity of no more than 0.2 microns are very expensive and are blocked very rapidly due to this very low porosity. This makes this process commercially impractical for most materials other than a few true solutions.

A practical method that is reasonable in cost and allows for commercial production run times (20 to 40 hours) would have tremendous commercial impact and will support the development of some very unique, healthful, and desirable commercial products and also lead to tremendous cost savings. Thus, the present invention describes such a method and, therefore, fills a much-needed void in the food and drug industry.

### SUMMARY OF THE INVENTION

The present invention involves the use of combinations of filtration and mild heat treatment, filtration and electromagnetic (non-ionizing) waves, or filtration and chemical treatments.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 illustrates one embodiment of the present invention.

FIG. 2 illustrates a second embodiment of the present invention.

FIG. 3 illustrates a switchable system allowing for near continuous processing of fluids, according to the present invention.

### DESCRIPTION OF THE PREFERRED EMBODIMENT

The present invention is a method and device that is useful for sterilization of materials such as foods, drugs, flavors, extracts, nutraceuticals, functional ingredients, and essences that can naturally support microbiological growth

Processing of foods and drugs to a level of sterility requires that microorganisms capable of reproducing in the food under normal non-refrigerated conditions of storage and distribution and viable microorganisms (including spores) of public health significance be either destroyed, inactivated, or excluded from the food or drug in question. There are two basic types of microorganisms to be considered in this case, namely, spore forming (difficult to destroy) and vegetative ((generally easily destroyed). Heat sensitive (labile) materials such as flavors, extracts, nutraceuticals, functional ingredients, and essences get destroyed along with microorganisms during a heat sterilization step aimed at destruction of spores. In order to prevent the destruction of heat sensitive (labile) materials such as flavors, extracts, nutraceuticals, functional ingredients, and essences, the current invention breaks the process into two separate and complementary processes, one aimed at excluding spores of microorganisms and certain other types of microorganisms that are larger than 0.45 microns by using a sterilizable sterilizing filter (depth filter or membrane filter) similar to the one commonly used by the wine industry and the second step aimed at the smaller vegetative microorganisms that may be able to pass through the 0.45 micron filter. Because of the fact that very heat resistant spores are larger than 0.45 micron and only vegetative (heat sensitive) microorganisms can be smaller than 0.45 microns, this invention works. After the filtration step, the material in question is treated with a mild process (low heat at 130° F. to 200° F. for 1-60 seconds), or electromagnetic waves (e.g. ultraviolet light), or chemical (super critical CO₂, ozone, or low concentration hydrogen peroxide). This second step is only required to destroy low resistance vegetative forms of microorganisms. The combination process results in a sterile finished product.

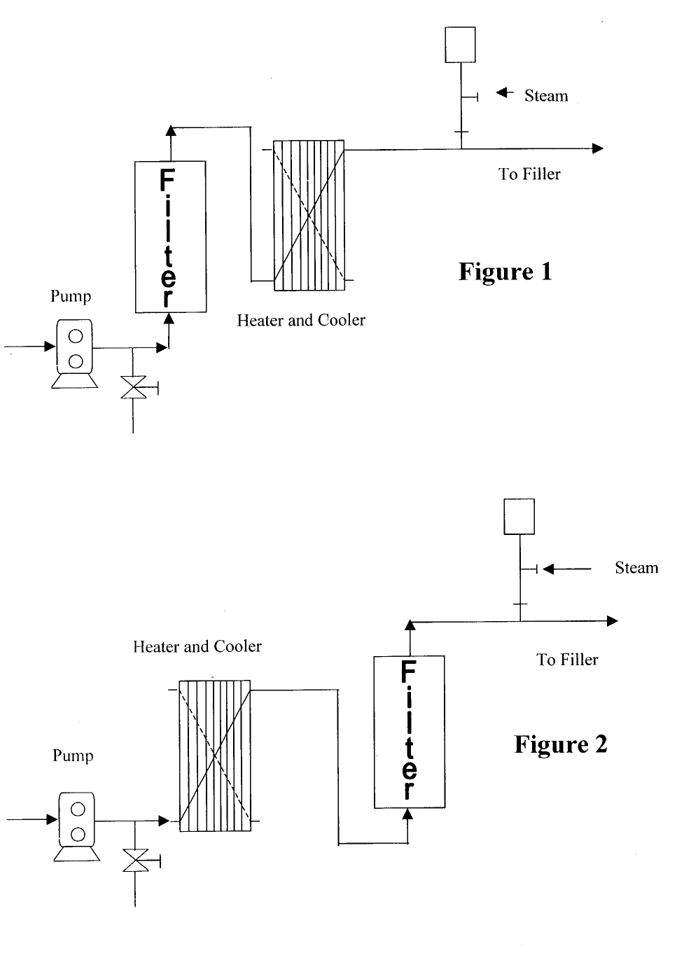

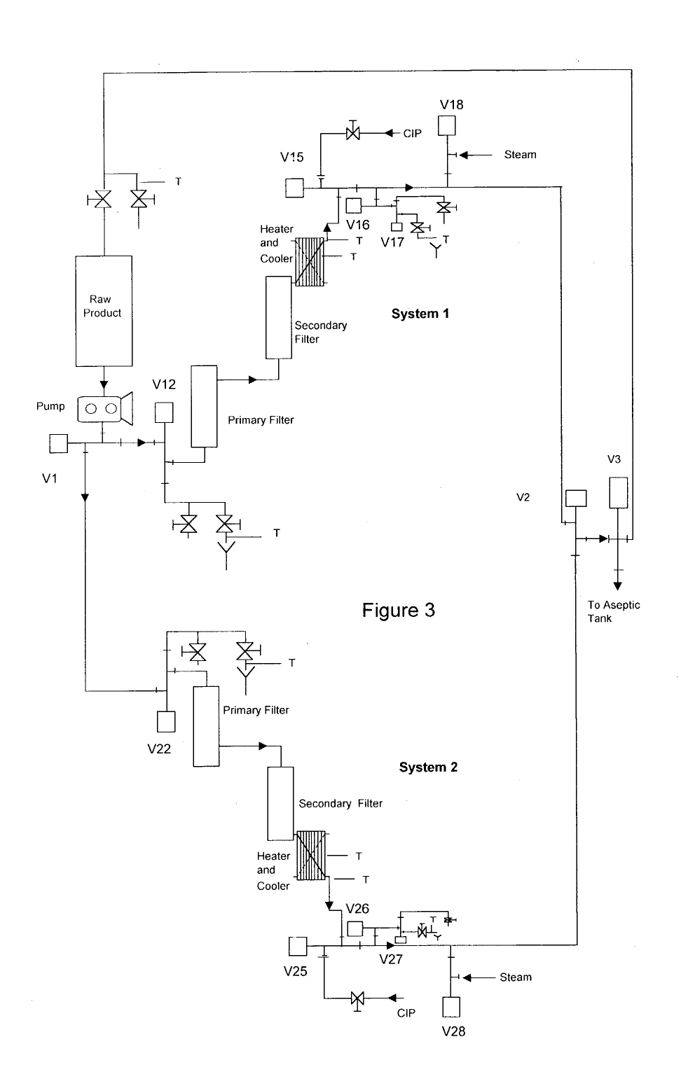

The unique part of this invention is the use of the combination of a 0.45-micron filter that is generally less expensive and does not get plugged easily (compared to a 0.2 micron filter) followed by a mild heat process to destroy the vegetative forms of microorganisms (FIG. 1). This same result can also be delivered by using a mild heat treatment first followed by the 0.45-micron filtration step (FIG. 2). It is contemplated that a virtually continuous flow processor may be designed that uses at least two separate systems according to the present invention (FIG. 3). In this embodiment, the flow of fluid to be sterilized is first direct through system 1. After a predetermined amount of fluid has passed through system 1, the flow is then directed through system 2. While the fluid is flowing through system 2, system 1 may be cleaned and resterilized in preparation to again receive the fluid flow. After a predetermined amount of fluid has passed through system 2 (and system 1 has been cleaned and resterilized), the fluid is redirected through system 1. This process may be repeated as many times as necessary.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for sterilizing fluids comprising the steps of:
a. filtering the fluid using a filter with a pore size of at most 0.45 microns; followed by the step of
b. mild processing the filtered fluid using a process selected from the group consisting of low temperature heating the filtered fluid to a temperature ranging between 130° F. to 200° F. for 1 to 60 seconds, electromagnetic wave treatment or chemical treatment.

2. The method according to claim 2 wherein the fluids are selected from the group comprising foods, drugs, flavors, extracts, nutraceuticals, functional ingredients, and essences that can naturally support microbiological growth.

3. A method for sterilizing fluids comprising the steps of:
a. mild processing the fluid using a process selected from the group consisting of low temperature heating the filtered fluid to a temperature ranging between 130° F. to 200° F. for 1 to 60 seconds, electromagnetic wave treatment or chemical treatment followed by the step of
b. filtering the processed fluid using a filter with a pore size of at most 0.45 microns.

4. The method according to claim 3 wherein the fluids are selected from the group comprising foods, drugs, flavors, extracts, nutraceuticals, functional ingredients, and essences that can naturally support microbiological growth.

5. A device for sterilizing fluids comprising a pump in fluid communication with a filter having a pore size of at most 0.45 microns, and a heater/cooler assembly in fluid communication between with the filter and a filler assembly.

6. The device according to claim 5 wherein the fluids are selected from the group comprising foods, drugs, flavors, extracts, nutraceuticals, functional ingredients, and essences that can naturally support microbiological growth.

7. A device for sterilizing fluids comprising a pump in fluid communication with a heater/cooler assembly and a filter having a pore size of at most 0.45 microns in fluid communication between with the heater/cooler assembly and a filler assembly.

8. The device according to claim 7 wherein the fluids are selected from the group comprising foods, drugs, flavors, extracts, nutraceuticals, functional ingredients, and essences that can naturally support microbiological growth.
